(19) United States
(12) Patent Application Publication
(10) Pub. No.: US 2011/0022389 A1
(43) Pub. Date: Jan. 27, 2011

(54) APPARATUS AND METHOD FOR IMPROVING PERFORMANCE OF VOICE RECOGNITION IN A PORTABLE TERMINAL

(75) Inventors: Young-Ri KIM, Suwon-si (KR); Jun-Yeop LEE, Seoul (KR)

Correspondence Address: Jefferson IP Law, LLP, 1130 Connecticut Ave., NW, Suite 420, Washington, DC, 20036, US

(73) Assignee: SAMSUNG ELECTRONICS CO. LTD., Suwon-si (KR)

(21) Appl. No.: 12/838,725

(22) Filed: Jul. 19, 2010

(30) Foreign Application Priority Data
Jul. 27, 2009 (KR) 10-2009-0068303

(51) Int. Cl. G10L 17/00

(52) U.S. Cl. 704/246; 704/E17.001

(57) ABSTRACT

An apparatus and method for improving the performance of voice recognition in a portable terminal are provided. The apparatus includes a voice recognition management unit, and a controller. After recognizing a user's voice and extracting at least one voice parameter, the voice recognition management unit determines if the extracted at least one voice parameter meets a criterion for determining one of success and failure of voice recognition. The controller analyzes a result of the determination by the voice recognition management unit and outputs a result of the analysis.

### PRIORITY

This application claims the benefit under 35 U.S.C. §119(a) of a Korean patent application filed in the Korean Intellectual Property Office on Jul. 27, 2009 and assigned Serial No. 10-2009-0068303, the entire disclosure of which is hereby incorporated by reference.

### BACKGROUND OF THE INVENTION

1. Field of the Invention

The present invention relates to an apparatus and method for improving the performance of voice recognition in a portable terminal. More particularly, the present invention relates to an apparatus and method for, after determining a cause of a failure of voice recognition, providing a voice recognition result in order to prevent the failure of voice recognition from repeatedly occurring in a portable terminal.

2. Description of the Related Art

Portable terminals have become increasingly popular, particularly, portable terminals enabling a wireless voice call and information exchange. Initially, the primary attributes of portable terminals was portability and a wireless call function. However, with the development of various technologies and the introduction of wireless Internet, the portable terminal's utility has significantly increased in scope. For example, the functions of the portable terminal may now include photographing an image by a digital camera, viewing a satellite broadcast, playing a game, remote control using local area communication, and the like, as well as simple telephony or schedule management.

Recently, portable terminals implementing a voice recognition technology have entered the market. Beyond a method of simply inputting a name of a stored phone number to establish a phone connection, a function of Speech To Text (STT), and the like, is currently included in the portable terminals as a voice recognition function.

In the voice recognition function, a user's voice command is recognized and a function corresponding to the user's voice command is performed.

In a case where the portable terminal fails to accurately recognize a user's voice command, the voice recognition function may not work properly. Thus, in this case, the portable terminal requests that the user reattempt the voice command.

At this time, the portable terminal informs the user of the failure to recognize the voice command with a limited text or a sound effect. For example, in a case where a user speaks a voice command “Call 1234567” and makes a phone call through voice recognition, if the portable terminal properly recognizes the voice command, the portable terminal establishes the phone connection for the corresponding phone number. However, if the portable terminal fails to recognize the voice command, the portable terminal requests that the user reattempt the voice command through a simple voice or limited text such as “Try again.”

The failure by the portable terminal to properly recognize the voice command can result from a failure to properly recognize a user's voice volume, a pronunciation, an accent, and the like. In this case, because a user cannot know a cause of a failure of the voice recognition, there is a problem that the user may reattempt the voice command in the same form and thus, the same failure of the voice recognition will occur.

The above problem leads to an inconvenience to the user, thus decreasing the likelihood that the user will use the voice recognition function.

Accordingly, there is a need for an apparatus and method for addressing the above problem, thus improving the rate of use of the voice recognition function in the portable terminal.

### SUMMARY OF THE INVENTION

An aspect of the present invention is to address at least the above-mentioned problems and/or disadvantages and to provide at least the advantages described below. Accordingly, an aspect of the present invention is to provide an apparatus and method for improving the performance of voice recognition in a portable terminal.

Another aspect of the present invention is to provide an apparatus and method for providing a result of voice recognition and improving the performance of voice recognition in a portable terminal.

A further aspect of the present invention is to provide an apparatus and method for providing information representing a cause of a failure of voice recognition in a portable terminal.

The above aspects are addressed by providing an apparatus and method for improving the performance of voice recognition in a portable terminal.

In accordance with an aspect of the present invention, an apparatus for improving the performance of voice recognition in a portable terminal is provided. The apparatus includes a voice recognition management unit, and a controller. After recognizing a user's voice and extracting at least one voice parameter, the voice recognition management unit determines if the extracted at least one voice parameter meets a criterion for determining one of success and failure of voice recognition. The controller analyzes a result of the determination by the voice recognition management unit and outputs a result of the analysis.

In accordance with another aspect of the present invention, a method for improving the performance of voice recognition in a portable terminal is provided. The method includes, after recognizing a user's voice and extracting at least one voice parameter, determining if the extracted at least one voice parameter meets a criterion for determining one of success and failure of voice recognition, and analyzing and outputting a result of the determination.

In accordance with yet another aspect of the present invention, an apparatus for voice recognition is provided. The apparatus includes a controller for analyzing at least one parameter used for voice recognition of a voice input from a user, and if voice recognition fails, for comparing the analyzed at least one parameter with a predefined criterion to determine a cause of the failure of voice recognition.

In accordance with still another aspect of the present invention, a method voice recognition is provided. The method includes analyzing at least one parameter used for voice recognition of a voice input from a user, and if voice recognition fails, comparing the analyzed at least one parameter with a predefined criterion to determine a cause of the failure of voice recognition.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following description taken in conjunction with the accompanying drawings in which:

FIG. 1 is a block diagram illustrating a construction of a portable terminal providing a voice recognition result according to an exemplary embodiment of the present invention;

FIG. 2 is a flow diagram illustrating an operation procedure of a portable terminal providing a voice recognition result according to an exemplary embodiment of the present invention;

FIG. 3 is a flow diagram illustrating a procedure of providing a voice recognition result in a portable terminal according to an exemplary embodiment of the present invention;

FIG. 4A is a diagram illustrating a screen outputting a voice recognition set value in a portable terminal according to an exemplary embodiment of the present invention;

FIG. 4B is a diagram illustrating a screen outputting information informing of a failure of voice recognition in a portable terminal according to an exemplary embodiment of the present invention;

FIG. 4C is a diagram illustrating a screen outputting information informing of a success of voice recognition in a portable terminal according to an exemplary embodiment of the present invention;

FIG. 5A is a diagram illustrating a screen outputting a voice recognition set value in a portable terminal according to an exemplary embodiment of the present invention;

FIG. 5B is a diagram illustrating a screen outputting information informing of a failure of voice recognition in a portable terminal according to an exemplary embodiment of the present invention; and

FIG. 5C is a diagram illustrating a screen outputting information informing of a success of voice recognition in a portable terminal according to an exemplary embodiment of the present invention.

Throughout the drawings, like reference numerals will be understood to refer to like parts, components and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention are provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

Exemplary embodiments of the present invention provide an apparatus and method for intuitively providing a voice recognition result in order to improve the performance of voice recognition in a portable terminal. The voice recognition result refers to the result of analyzing a cause of a failure of voice recognition in order to prevent a user from repeatedly inputting a voice in the same form and thereby causing the same failure of the voice recognition to be repeated. In the following description, the term “voice recognition set value” refers to a value serving as a criterion for determining if a user's voice corresponds to a normal voice. Also, the term “voice parameter” refers to a parameter for determining if a user's voice corresponds to a normal voice for a voice recognition function. Herein, the voice parameter may be at least one of a user's voice volume (i.e., speaking voice volume), a pronunciation accuracy, an accent, and the like. Also, the voice parameter may be used to determine if the user's voice corresponds to a normal voice by determining if the user's voice does not correspond to a normal voice.

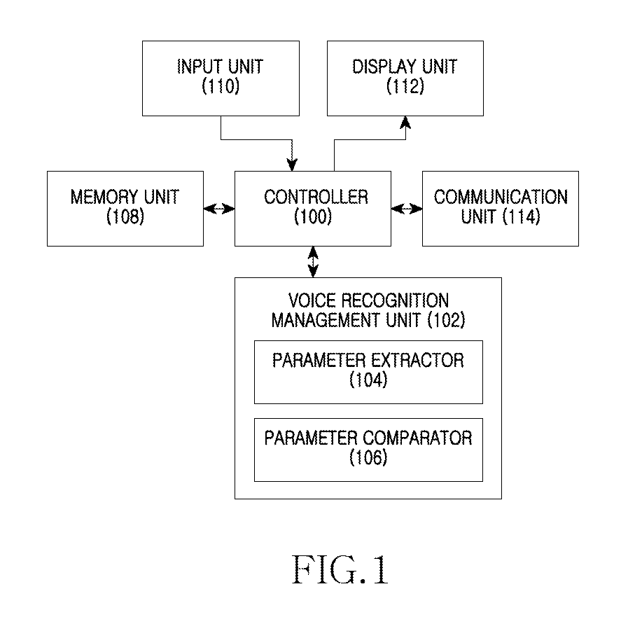

FIG. 1 is a block diagram illustrating a construction of a portable terminal providing a voice recognition result according to an exemplary embodiment of the present invention.

Referring to FIG. 1, the portable terminal may include a controller 100, a voice recognition management unit 102, a memory unit 108, an input unit 110, a display unit 112, and a communication unit 114. The voice recognition management unit 102 may include a parameter extractor 104 and a parameter comparator 106. Although not shown, the portable terminal may include various other components.

The controller 100 of the portable terminal controls general operations of the portable terminal. For example, the controller 100 may perform processing and control for voice telephony and data communication. In addition to general functions, according to an exemplary embodiment of the present invention, after recognizing a user's voice, the controller 100 may determine if the user's voice corresponds to a normal voice for controlling a voice recognition function or an abnormal voice. After that, the controller 100 may process to output a result of the determination made regarding the user's voice such that a user is made aware of a result of the voice recognition. For example, in a case where the controller 100 properly recognizes a user's voice, the controller 100 can output information that at least one of a user's voice volume (i.e., speaking voice volume), a pronunciation accuracy, an accent, and the like, meet the condition of a voice recognition set value serving as a criterion of the voice determination. In contrast, in a case where the controller 100 fails to properly recognize the user's voice, the controller 100 may output information on an item (i.e., a parameter) not meeting the condition of the voice recognition set value, among items of at least one of the user's voice volume (i.e., speaking voice volume), the pronunciation accuracy, and the accent.

Accordingly, in the case where the controller 100 outputs information that a user's voice volume does not meet the condition of the voice recognition set value, the user of the portable terminal can control their voice volume when reattempting to input the voice command, thereby mitigating the likelihood that the voice recognition will again fail for the same reason.

Under the control of the controller 100, after recognizing a user's voice and determining if the user's voice corresponds to a normal voice for controlling a voice recognition function, the voice recognition management unit 102 may process to output a voice recognition result such that a user can be made aware of the voice recognition result.

At this time, the voice recognition management unit 100 may process the parameter extractor 104 to extract a voice parameter from the user's voice, and acquire the voice parameter for determining if the user's voice corresponds to the normal voice. Here, the voice parameter, which is a parameter for determining if the user's voice corresponds to the normal voice for the voice recognition function, can be the at least one of the user's voice volume (i.e., speaking voice volume), the pronunciation accuracy, the accent, and the like.

Also, the voice recognition management unit 102 determines if the user's voice corresponds to the normal voice using the voice parameter acquired by the parameter extractor 104. At this time, the voice recognition management unit 102 uses the parameter comparator 106 to determine if the user's voice corresponds to the normal voice.

The parameter extractor 104 may recognize a user's voice, and acquire a voice parameter from the user's voice. The parameter comparator 106 may compare the voice parameter acquired by the parameter extractor 104 with a voice recognition set value, and determine if the user's voice corresponds to the normal voice. Here, the voice recognition set value refers to a value serving as a criterion for determining if the user's voice corresponds to the normal voice.

For example, in a case where the parameter comparator 106 uses a voice recognition set value for a user's voice volume (i.e., speaking voice volume), the parameter comparator 106 may compare a user's voice volume (i.e., speaking voice volume) parameter acquired by the parameter extractor 104 with the voice recognition set value. In a case where the acquired voice parameter is greater than (and/or less than) the voice recognition set value serving as the criterion, the parameter comparator 106 may determine that a user's voice corresponds to a normal voice.

On the other hand, in a case where the parameter comparator 106 uses voice recognition set values for at least one of a user's voice volume (i.e., speaking voice volume), a pronunciation accuracy, and an accent, the parameter comparator 106 may compare the at least one of the user's voice volume (i.e., speaking voice volume), pronunciation accuracy, and accent parameters acquired by the parameter extractor 104 with the voice recognition set values. In a case where the acquired at least one user's voice volume, pronunciation accuracy, and accent parameters are greater than (and/or less than) the voice recognition set values serving as the criterion, the parameter comparator 106 can determine that a user's voice corresponds to a normal voice.

Accordingly, in a case where the controller 100 determines that a recognized user's voice corresponds to a normal voice for controlling a voice recognition function, the controller 100 can output information that the item of the voice parameter meets the voice recognition set value serving as the criterion, thereby providing a voice recognition result.

In contrast, in a case where the controller 100 determines that the recognized user's voice does not correspond to the normal voice for controlling the voice recognition function, the controller 100 provides information on the voice parameter not meeting the voice recognition set value serving as the criterion, thereby preventing the same error of voice recognition from being repeated when the user reattempts to input the user's voice.

The memory unit 108 includes, for example, a Read Only Memory (ROM), a Random Access Memory (RAM), a flash ROM, and the like. The ROM may store a microcode (i.e., code) of a program for processing and controlling the controller 100 and the voice recognition management unit 102, and a variety of types of reference data.

The RAM, a working memory of the controller 100, may store temporary data generated during execution of a variety of types of programs. The flash ROM stores a plurality of types of updateable depository data such as a phone book, an outgoing message, an incoming message, and information on a user's touch input point. According to an exemplary embodiment of the present invention, the flash ROM may store a voice recognition set value serving as a criterion for determining a normal voice in the portable terminal.

The input unit 110 may include at least one of numeral key buttons ‘0’ to ‘9’, a menu button, a cancel button (delete), an OK button, a talk button, an end button, an Internet button, navigation key (or direction key) buttons, a plurality of function keys such as a character input key, and the like. The input unit 110 provides key input data corresponding to a key pressed by a user to the controller 100.

The display unit 112 may display state information generated during operation of the portable terminal 100, limited number of characters, a large amount of moving pictures, still pictures, and the like. The display unit 112 may be a color Liquid Crystal Display (LCD), an Active Mode Organic Light Emitting Diode (AMOLED), and the like. The display unit 112 may include a touch input device. In the case where the display unit 112 is applied to a portable terminal of a touch input scheme, the display unit 112 can be used as an input device.

The communication unit 114 performs a function of transmitting/receiving and processing of a radio signal that is input/output through an antenna (not illustrated). For example, in a transmission mode, the communication unit 114 performs a function of processing original data through channel coding and spreading, converting the original data into a Radio Frequency (RF) signal, and transmitting the RF signal. In a reception mode, the communication unit 114 performs a function of converting a received RF signal into a baseband signal, processing the baseband signal through de-spreading and channel decoding, and restoring the signal to original data.

A role of the voice recognition management unit 102 (or any other of the components) can be implemented by the controller 100 of the portable terminal. However, while these components are shown as being separately constructed in an exemplary embodiment of the present invention, this is merely for convenience of description and is not intended to limit the scope of the present invention. It shall be understood by those skilled in the art that various modifications of construction can be made within the scope of the present invention. For example, construction of the portable terminal can also be such that all or any number of the components are processed in the controller 100.

The above description is made for an apparatus for intuitively providing a voice recognition result in order to improve the performance of voice recognition in a portable terminal according to an exemplary embodiment of the present invention. The following description is made for a method for providing the result of analyzing a cause of a failure of voice recognition in order to prevent a user from repeatedly inputting a voice in the same form and thereby causing the same failure of voice recognition to be repeated, and for improving the performance of voice recognition, using the apparatus according to the exemplary embodiment of the present invention.

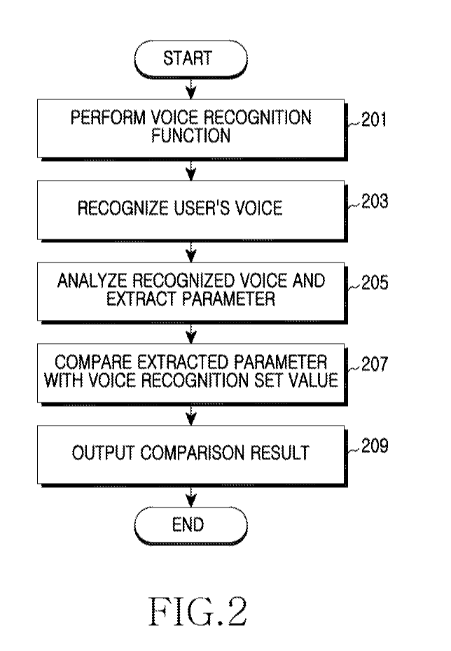

FIG. 2 is a flow diagram illustrating an operation procedure of a portable terminal providing a voice recognition result according to an exemplary embodiment of the present invention.

Referring to FIG. 2, in step 201, the portable terminal performs a voice recognition function and receives a voice input from a user for function control. Then, the portable terminal proceeds to step 203 and performs a process of recognizing a user's voice.

Then, the portable terminal proceeds to step 205 and analyzes the recognized voice of step 203 and extracts at least one voice parameter from the voice. Here, the at least one voice parameter, which is a parameter for determining if the user's voice corresponds to a normal voice for a voice recognition function, can be at least one of a user's voice volume (i.e., speaking voice volume), a pronunciation accuracy, an accent, and the like.

After that, the portable terminal proceeds to step 207 and compares the extracted voice parameter with a voice recognition set value and determines if the user's voice corresponds to the normal voice for controlling the voice recognition function. Here, the voice recognition set value refers to at least one value serving as a criterion for determining if the user's voice corresponds to a normal voice. In a case where the extracted voice parameter is equal to or greater than (and/or equal to or less than) the voice recognition set value, the portable terminal may determine that the user's voice corresponds to the normal voice for the voice recognition function.

Next, the portable terminal proceeds to step 209 and processes to output the comparison result of step 207. In more detail, in a case where the portable terminal determines that the user's voice does not correspond to the normal voice for the voice recognition function in the comparison process, the portable terminal outputs information to the user corresponding to the at least one voice parameter that is less than (and/or greater than) the voice recognition set value. Accordingly, a user may then vocalize clearly so as to increase a voice recognition rate using the corresponding information.

For example, in a case where the portable terminal determines that a pronunciation accuracy parameter among the voice parameters is a parameter representing an abnormal voice, the portable terminal may output information that the pronunciation accuracy parameter is less than (and/or greater than) the voice recognition set value. Accordingly, in order to increase a voice recognition rate, a user of the portable terminal may vocalize in a normal voice for a voice recognition function with a more clear pronunciation than that of a previously vocalized voice.

After that, the portable terminal terminates the procedure according to the exemplary embodiment of the present invention.

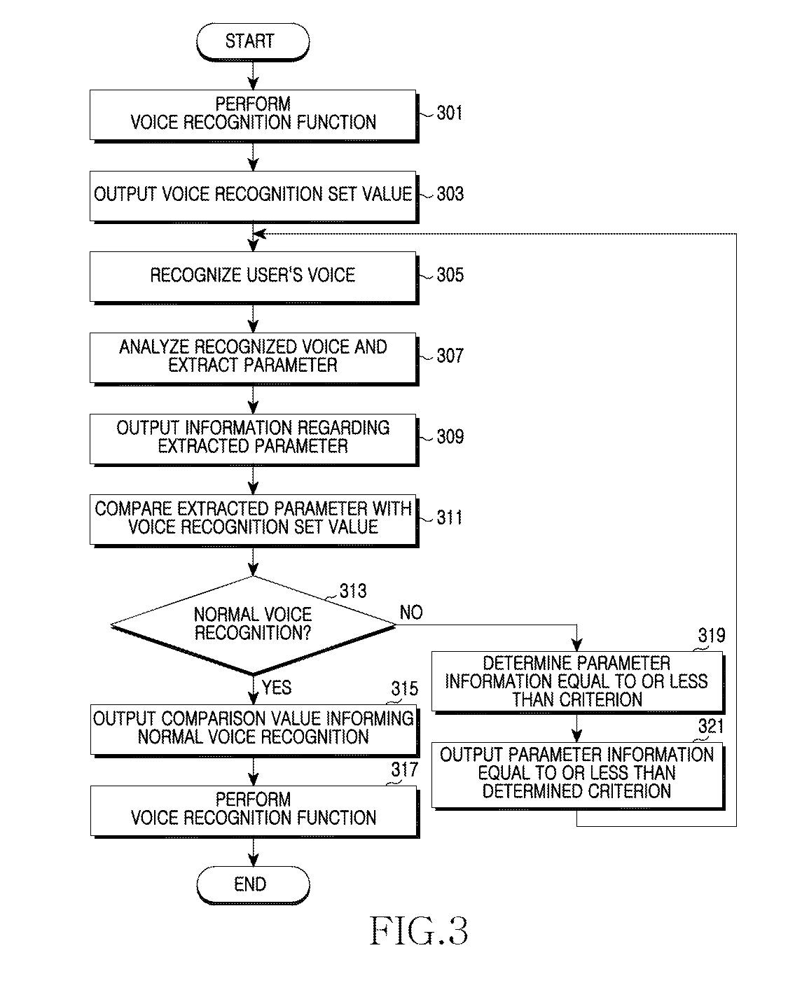

FIG. 3 is a flow diagram illustrating a procedure of providing a voice recognition result in a portable terminal according to an exemplary embodiment of the present invention.

Referring to FIG. 3, in step 301, the portable terminal performs a voice recognition function. Then, the portable terminal proceeds to step 303 and processes to output a voice recognition set value. Here, the voice recognition set value refers to a value serving as a criterion for determining if a user's voice corresponds to a normal voice. The portable terminal can display the voice recognition set value by means of a specific indicator. For example, the portable terminal can display the voice recognition set value by means of an indicator having a shape of ‘Δ’. Sides of the indicator having the shape of ‘Δ’ can denote the user's voice volume (i.e., speaking voice volume), pronunciation accuracy, and accent values, respectively.

After that, the portable terminal proceeds to step 305 and recognizes a user's voice. Then, the portable terminal proceeds to step 307 and analyzes the recognized user's voice, extracting at least one voice parameter from the user's voice. Here, the at least one voice parameter, which is a parameter for determining if a user's voice corresponds to a normal voice for a voice recognition function, can be at least one of a user's voice volume (i.e., speaking voice volume), a pronunciation accuracy, an accent, and the like. In a case where the portable terminal uses the at least one of the user's voice volume (i.e., speaking voice volume), the pronunciation accuracy, and the accent as voice recognition set values, the portable terminal may extract one or more voice parameters corresponding to the at least one of the user's voice volume (i.e., speaking voice volume), the pronunciation accuracy, and the accent. The portable terminal then proceeds to step 309 and outputs information regarding the extracted voice parameters.

Then, after outputting information regarding the extracted one or more voice parameters, the portable terminal proceeds to step 311 and performs a process of comparing the extracted one or more voice parameters with the corresponding one or more voice recognition set values. Step 311 is a process for determining if the user's voice corresponds to the normal voice for controlling voice recognition or an abnormal voice.

Then, the portable terminal proceeds to step 313 and determines if the user's voice corresponds to normal voice.

In a case where the portable terminal determines that the user's voice corresponds to an abnormal voice for controlling the voice recognition function in step 313, the portable terminal proceeds to step 319 and determines voice parameter information equal to or less than (and/or equal to or greater than) a criterion (i.e., voice parameter information determined to be the abnormal voice). Then, the portable terminal proceeds to step 321 and processes to output the determined voice parameter information equal to or less than (and/or equal to or greater than) the criterion.

At this time, the portable terminal outputs information representing that the extracted voice parameter of step 311 is less than (and/or greater than) the voice recognition set value. In a case where the voice recognition set value is comprised of the at least one of the user's voice volume (i.e., speaking voice volume), the pronunciation accuracy, and the accent, the portable terminal outputs comparison values between the voice parameter information of the at least one of the user's voice volume (i.e., speaking voice volume), the pronunciation accuracy, and the accent, and the voice recognition set values.

After that, the portable terminal returns to step 305 and again determines a user's voice.

On the other hand, in a case where the portable terminal determines that the user's voice corresponds to a normal voice for controlling the voice recognition function in step 313, the portable terminal proceeds to step 315 and outputs a comparison value informing the user of the normal voice recognition. Here, step 315 outputs information representing that the extracted voice parameters of step 311 are equal to or are greater than (and/or equal to or less than) the voice recognition set values. In a case where the voice recognition set value is comprised of the at least one of the user's voice volume (i.e., speaking voice volume), the pronunciation accuracy, and the accent, the portable terminal outputs comparison values between voice parameter information of the at least one of the user's voice volume (i.e., speaking voice volume), the pronunciation accuracy, and the accent, and the voice recognition set values.

After that, the portable terminal proceeds to step 317 and performs a voice recognition function corresponding to the user's voice.

Then, the portable terminal terminates the procedure according to the exemplary embodiment of the present invention.

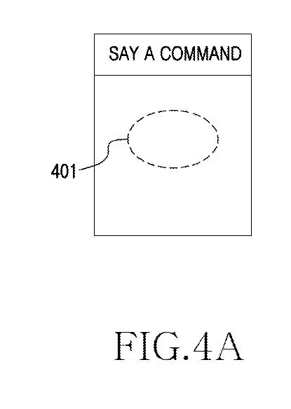

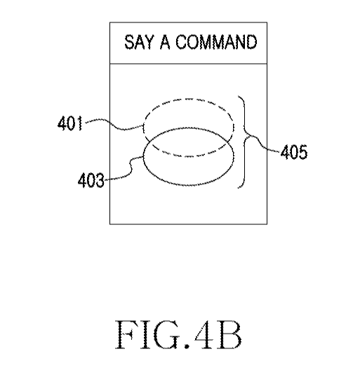

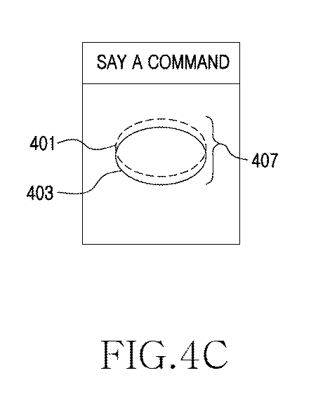

FIGS. 4A-4C are diagrams illustrating a screen of a portable terminal providing voice recognition results according to exemplary embodiments of the present invention.

FIG. 4A is a diagram illustrating a screen outputting a voice recognition set value in a portable terminal according to an exemplary embodiment of the present invention.

Referring to FIG. 4A, the portable terminal outputs a voice recognition set value 401, shown with a dotted-line, serving as a criterion for determining a normal voice in the portable terminal According to an exemplary embodiment of the present invention, the portable terminal can display an indicator in the shape of an ‘O’, that corresponds to a voice recognition set value of any one of a user's voice volume (i.e., speaking voice volume), a pronunciation accuracy, and an accent.

FIG. 4B is a diagram illustrating a screen outputting information informing of a failure of voice recognition in a portable terminal according to an exemplary embodiment of the present invention.

Referring to FIG. 4B, after recognizing a user's voice and extracting voice parameter information from the user's voice, the portable terminal compares the extracted voice parameter information with a voice recognition set value, and provides a voice recognition result. In a case where the portable terminal intends to provide the voice recognition result, the portable terminal outputs the dotted-lined voice recognition set value 401 and solid-lined extracted voice parameter information 403 together such that a user easily determines the voice recognition result.

For instance, in a case where the portable terminal determines that voice recognition fails, as illustrated in FIG. 4B, the portable terminal increases a difference of positions 405 between the extracted voice parameter and the voice recognition set value. At this time, the portable terminal compares the extracted voice parameter with the voice recognition set value and determines a success or failure of voice recognition. The portable terminal determines that an accuracy of voice recognition decreases as the extracted voice parameter gets lower than (and/or greater than) the voice recognition set value. As described above, the portable terminal controls positions of the extracted voice parameter and the voice recognition set value in order to represent the accuracy of the voice recognition. That is, the portable terminal increases a difference of positions 405 between the extracted voice parameter and the voice recognition set value as the accuracy of the voice recognition decreases.

FIG. 4C is a diagram illustrating a screen outputting information informing of a success of voice recognition in a portable terminal according to an exemplary embodiment of the present invention.

Referring to FIG. 4C, after recognizing a user's voice and extracting voice parameter information from the user's voice, the portable terminal compares the solid-lined extracted voice parameter 403 information with the dotted-lined voice recognition set value 401 and provides a voice recognition result.

For example, in a case where the portable terminal determines that voice recognition is successful, as illustrated in FIG. 4C, the portable terminal makes positions 407 of the extracted voice parameter and the voice recognition set value substantially identical, to inform the user that the extracted voice parameter meets the condition of the voice recognition set value.

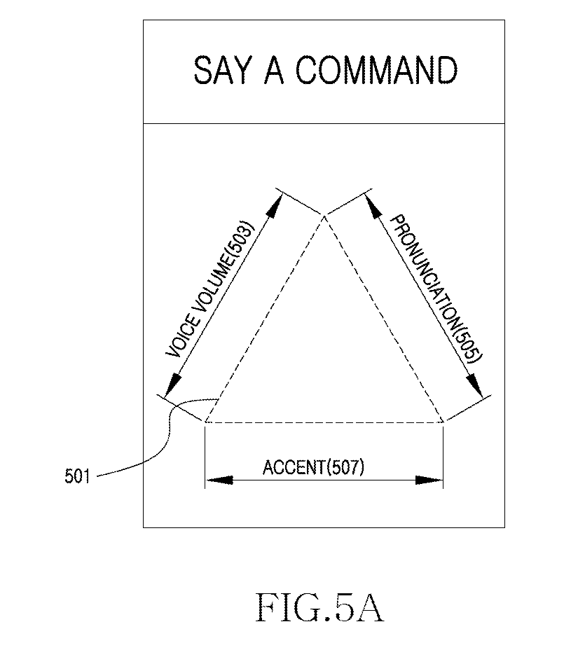

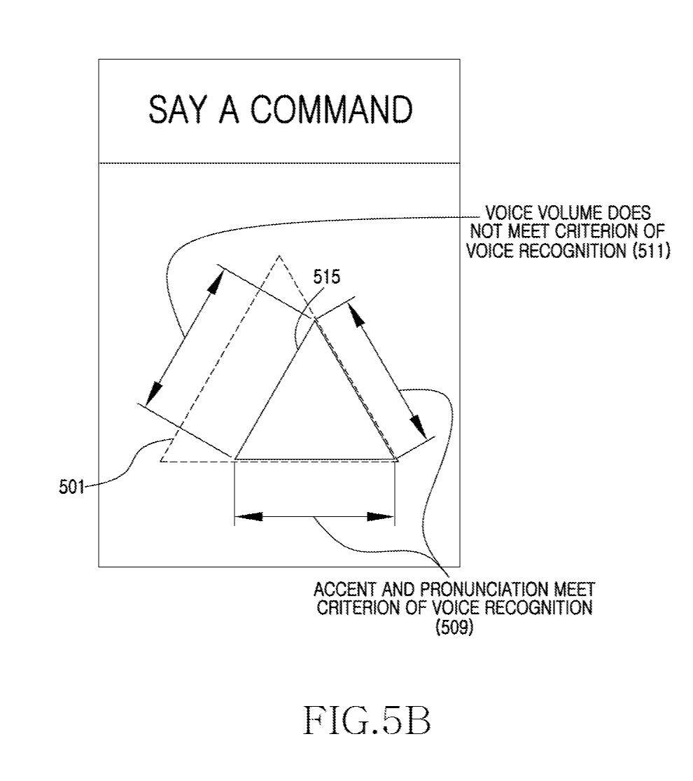

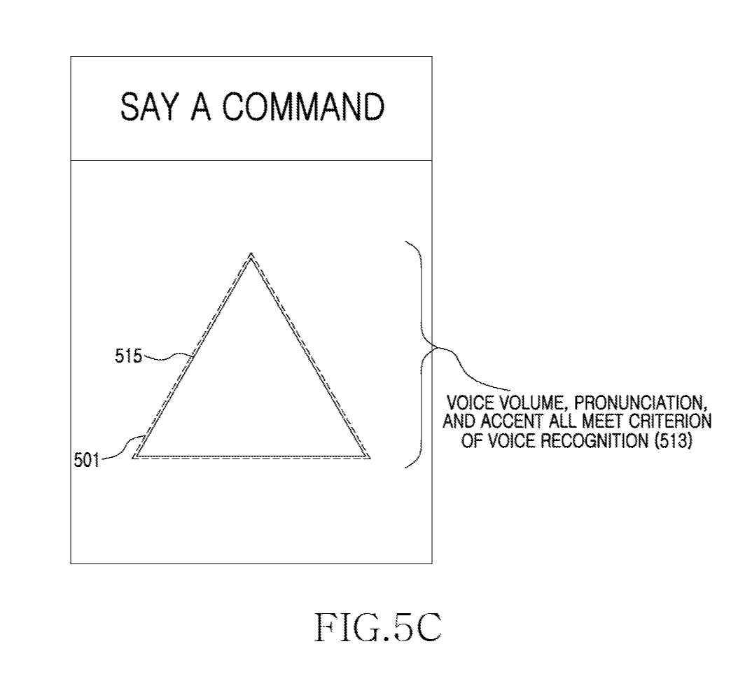

FIGS. 5A-5C are diagrams illustrating a screen of a portable terminal providing voice recognition results according to exemplary embodiments of the present invention.

FIG. 5A is a diagram illustrating a screen outputting a voice recognition set value in a portable terminal according to an exemplary embodiment of the present invention.

Referring to FIG. 5A, the portable terminal outputs a voice recognition set value serving as a criterion for determining a normal voice in the portable terminal. According to another exemplary embodiment of the present invention, the portable terminal can display, by a dotted-lined triangle (Δ), a voice recognition set value 501 including a user's voice volume (i.e., speaking voice volume) 503, a pronunciation accuracy 505, and an accent 507. That is, sides of the dotted-lined triangle (Δ) represent the user's voice volume (i.e., speaking voice volume) 503, the pronunciation accuracy 505, and the accent 507, respectively.

FIG. 5B is a diagram illustrating a screen outputting information informing of a failure of voice recognition in a portable terminal according to an exemplary embodiment of the present invention.

Referring to FIG. 5B, the portable terminal outputs the voice recognition set value 501 (i.e., the dotted-lined triangle) and extracted voice parameter information 515 (i.e., a solid-lined triangle) together such that a user easily determines a voice recognition result.

For example, in a case where the portable terminal determines that the voice recognition fails, as illustrated in FIG. 5B, the portable terminal differentiates differences of positions between the voice recognition set value 501 and the extracted voice parameters 515.

At this time, unlike FIGS. 4A-4C, the portable terminal compares the user's voice volume (i.e., speaking voice volume) 503, pronunciation accuracy 505, and accent 507 of the voice recognition set value 501 with the extracted voice parameters 515, respectively, and then, outputs comparison values for the respective items.

For instance, in a case where, among the user's voice volume 503 (i.e., speaking voice volume), pronunciation accuracy 505, and accent parameters 507 of the extracted voice parameter information 515, the pronunciation accuracy 505 and accent parameters 507 are greater than the pronunciation accuracy 505 and accent 507 of the voice recognition set value 501, the portable terminal overlaps 509 both sides of a triangle 515 of items (i.e., the pronunciation accuracy 505 and accent parameters 507) greater than the pronunciation accuracy 505 and accent 507 of the voice recognition set value 501, with both sides of the dotted-lined triangle of the voice recognition set value 501. That is, the portable terminal outputs 511 a non-overlapped side of the solid-lined triangle 515 corresponding to the voice volume 503 in order to represent that the voice volume 503 is a cause of a failure of voice recognition. By determining that the failure was caused by the output voice parameter (i.e., the voice volume parameter) 503, a user of the portable terminal can reattempt a voice recognition function while focusing on enhancing the voice volume 503.

FIG. 5C is a diagram illustrating a screen outputting information informing of a success of voice recognition in a portable terminal according to an exemplary embodiment of the present invention.

Referring to FIG. 5C, after recognizing a user's voice and extracting voice parameter information 515 from the user's voice as above, the portable terminal compares the extracted voice parameter information 515 with a voice recognition set value 501, and provides a voice recognition result.

For example, in a case where the portable terminal determines that voice recognition is successful because all (or a subset of) items of user's voice volume (i.e., speaking voice volume) 503, pronunciation accuracy 505, and accent parameters 507 are greater than (and/or less than) a user's voice volume (i.e., speaking voice volume) 503, a pronunciation accuracy 505, and an accent 507 of the voice recognition set value 501, as illustrated in FIG. 5C, the portable terminal positions the voice recognition set value 501 (i.e., a dotted-lined triangle) and the extracted voice parameter (i.e., a solid-lined triangle) 515 so as to substantially overlap in order to inform a user that the extracted voice parameter 515 meets the condition of the voice recognition set value 501.

As described above, exemplary embodiments of the present invention relate to an apparatus and method for improving the performance of voice recognition in a portable terminal. By providing a user with information on a cause of a failure of voice recognition, exemplary embodiments of the present invention can mitigate the likelihood that the same type of failure that occurred during voice recognition will be repeated when the user reattempts voice recognition.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. An apparatus for improving the performance of voice recognition in a portable terminal, the apparatus comprising:
a voice recognition management unit for, after recognizing a user's voice and extracting at least one voice parameter, determining if the extracted at least one voice parameter meets a criterion for determining one of a success and failure of voice recognition; and
a controller for analyzing a result of the determination by the voice recognition management unit and for outputting a result of the analysis.

2. The apparatus of claim 1, wherein, if voice recognition is determined to be successful, the controller outputs information informing the user that the at least one voice parameter meets the criterion and, if voice recognition is determined to have failed, the controller outputs information informing the user that one or more of the at least one voice parameter does not meet the criterion.

3. The apparatus of claim 2, wherein the at least one voice parameter comprises at least one parameter for determining if a user's voice corresponds to a normal voice for a voice recognition function.

4. The apparatus of claim 3, wherein the at least one voice parameter comprises at least one of a user's voice volume, a pronunciation accuracy, and an accent.

5. The apparatus of claim 2, wherein, after determining the one of success and failure of voice recognition, the controller displays the result of the determination using a specific indicator.

6. The apparatus of claim 2, wherein, if voice recognition is determined to have failed, the controller outputs the information corresponding to one or more of the at least one voice parameter not meeting the criterion, wherein the information assists the user in avoiding the cause of the failure when reattempting voice recognition.

7. A method for improving the performance of voice recognition in a portable terminal, the method comprising:
after recognizing a user's voice and extracting at least one voice parameter, determining if the extracted at least one voice parameter meets a criterion for determining one of success and failure of voice recognition; and
analyzing and outputting a result of the determination.

8. The method of claim 7, wherein the analyzing and outputting of the result of the determination comprises, if voice recognition is determined to be successful, outputting information informing the user that one or more of the at least one voice parameter meets the criterion, and, if voice recognition is determined to have failed, outputting information informing the user that one or more of the at least one voice parameter does not meet the criterion.

9. The method of claim 8, wherein the at least one voice parameter comprises at least one parameter for determining if a user's voice corresponds to a normal voice for a voice recognition function.

10. The method of claim 9, wherein the at least one voice parameter comprises at least one of a user's voice volume, a pronunciation accuracy, and an accent.

11. The method of claim 8, wherein, after determining the one of success and failure of voice recognition, a result of the determination is displayed using a specific indicator.

12. The method of claim 8, wherein, if voice recognition is determined to have failed, outputting the information corresponding to the one or more of the at least one voice parameter not meeting the criterion, wherein the information assists the user in avoiding the cause of the failure when reattempting voice recognition.

13. An apparatus for voice recognition, the apparatus comprising a controller for analyzing at least one parameter used for voice recognition of a voice input from a user, and if voice recognition fails, for comparing the analyzed at least one parameter with a predefined criterion to determine a cause of the failure of voice recognition.

14. The apparatus of claim 13, wherein, after determining the cause of the failure of voice recognition, the controller outputs the determined cause of the failure of voice recognition to the user.

15. The apparatus of claim 13, wherein the at least one parameter comprises at least one parameter for determining if the voice input from the user corresponds to a normal voice for a voice recognition function.

16. The apparatus of claim 15, wherein the at least one voice parameter comprises at least one of a user's voice volume, a pronunciation accuracy, and an accent.

17. A method for voice recognition, the method comprising:
analyzing at least one parameter used for voice recognition of a voice input from a user; and
if voice recognition fails, comparing the analyzed at least one parameter with a predefined criterion to determine a cause of the failure of voice recognition.

18. The method of claim 17, wherein, after determining the cause of the failure of voice recognition, outputting the determined cause of the failure of voice recognition to the user.

19. The method of claim 17, wherein the at least one parameter comprises at least one parameter for determining if the voice input from the user corresponds to a normal voice for a voice recognition function.

20. The method of claim 19, wherein the at least one voice parameter comprises at least one of a user's voice volume, a pronunciation accuracy, and an accent.
